(19) United States
(12) Patent Application Publication
(10) Pub. No.: US 2021/0312547 A1
(43) Pub. Date: Oct. 7, 2021

(54) MULTI-ENERGY TRADING AND MANAGEMENT PLATFORM BASED ON BLOCKCHAIN

(71) Applicants: Xi'an Jiaotong University, Xi'an City (CN); Northwest Power Grid Co., Ltd., Xi'an City (CN); Electric Power Research Institute Of Shanxi Grid Co., Ltd., Xi'an City (CN)

(72) Inventors: Tao Ding, Xi'an city (CN); Jiangbin Dong, Xi'an city (CN); Chenggang Mu, Xi'an city (CN); Ming Qu, Xi'an city (CN); Keer Ning, Xi'an city (CN); Xiaobo Dong, Xi'an city (CN); Jie Qi, Xi'an city (CN); Xiaomeng Zhang, Xi'an city (CN); Yuankang He, Xi'an City (CN); Tianen Chen, Xi'an City (CN); Yongqing Wang, Xi'an City (CN); Jian Liu, Xi'an City (CN)

(21) Appl. No.: 17/157,221

(22) Filed: Jan. 25, 2021

(30) Foreign Application Priority Data
Apr. 1, 2020 (CN) 202010250670.4

(51) Int. Cl. G06Q 40/04; G06Q 50/06; G06Q 20/38; G06Q 10/10; G06F 16/27; G06F 16/23; G06F 9/54

(52) U.S. Cl. CPC G06Q 40/04; G06Q 50/06; G06Q 20/389; G06F 9/547; G06Q 10/101; G06F 16/27; G06F 16/2379; G06Q 10/103

(57) ABSTRACT

This invention provides a method for building a multi-energy trading and management platform based on blockchain. Based on the attributes of different functions to be implemented in the energy trading and management platform, the platform is built by combining different advantages of blockchain technology and database technology. Deploy the functions of issuing transactions, matching transactions, and querying transaction information in Ethereum smart contract, store user registration information in a traditional database, and establish a mapping relationship between real information and lengthy blockchain accounts to make information of transactions on the market be displayed with real names. This method not only meets the needs of energy distributed transactions but also avoids the problem of incompatible string type data in Ethereum smart contracts which affects system performance. At the same time, the transaction data displayed with real names ensures the openness and legality of the transaction system. It has a strong reference significance for the development of new models of distributed energy trading.

### FIELD OF THE INVENTION

This invention belongs to the development field of multi-energy distributed transaction and management platform. Mainly involves the landing operation mode of distributed energy transaction and the integration development of blockchain technology and traditional database technology.

### BACKGROUND OF THE INVENTION

With the transformation of blockchain technology from digital currency to more industrial development, as well as the continuous reform of energy marketization, the application of blockchain technology to the energy field has great potential. Distributed and decentralized characteristics proposed by blockchain are very consistent with the distributed transaction requirements proposed by energy field. Taking electric power as an example, smart contract technology in blockchain can realize automatic coordination of electricity demand for power generators and users, to alleviate the pressure of distribution network. At the same time, the openness of blockchain ensures the security of energy trading and reduces the cost of trust and management and maintenance in energy trading.

At present, there have been a lot of research achievements in the development of smart contracts in blockchain. The rationality of smart contracts in the energy sector can be verified through experiments, which provides the possibility to further promote the application of blockchain technology in energy distributed transactions.

But there are still many problems with blockchain technology that has been developed for energy trading. For example, most smart contracts currently rely only on simulation environments, and they can only run based on a visual level of the platform. At present, the participation of ordinary users is very limited, which hinders the implementation of blockchain technology. Moreover, the performance of blockchain technology is still greatly challenged, and the implementation of too much information relying on a smart contract will consume more resources. Meanwhile, the original transaction information based on the blockchain is complex and lengthy, and the individual accounts in the blockchain are all 20-byte addresses. This leads to the fact that even though the transaction information in the blockchain is open and transparent, there is still no real judgment on the two parties of the transaction. On the other hand, users entering market do not provide their real identity, which is not consistent with the open and transparent trading market. Furthermore, for market managers, there is no guarantee that market transactions will be legitimate. These problems hinder the application of blockchain technology in the energy field.

### SUMMARY OF THE INVENTION

To overcome the above-mentioned problems, the object of the present invention is to provide a method for building a multi-energy trading and management platform based on blockchain, to solve the problem that the existing blockchain technology is difficult to land in the field of energy trading, providing new solutions for the application of blockchain energy

To achieve the above objectives, the present invention adopts the following technical solutions:

The building method of the multi-energy trading and management platform includes the following steps:

(1) Based on the characteristics of blockchain decentralization and the advantages of stable performance of traditional databases, the combination of blockchain technology and database technology is used in different functions of this invention. Blockchain technology is used for multi-energy distributed transactions and traditional databases are used to store complex string data. The system performance is improved and the resource consumption is reduced without violating the characteristics of distributed transactions;

(2) Build a complete multi-energy transaction and management system based on the combination of blockchain technology and database. The system structure includes four parts: blockchain layer, smart contract layer, front-end interaction layer, and database layer.

A method for building a multi-energy trading and management platform based on blockchain according to claim 1, characterized in that, step (1) includes the following steps:

(201) Determine the functions implemented by the energy trading platform. For users, the energy trading platform can enable users to issue transactions, view personal transaction results, view blockchain information generated by the exchange, view and change personal registration information, etc. For administrators, it is able for them to transfer money to a user, check the user's personal information and manage energy, etc.

(202) Determine the functions implemented by blockchain technology. Based on the distributed characteristics of blockchain technology, the main part of the energy transaction is deployed on blockchain, which includes releasing energy, matching transactions automatically, and viewing the transaction results and the blockchain information generated by it. Meanwhile, users tend to trade in different types of energy, so the function of adding or deleting energy is also placed in blockchain. All the above functions are realized based on Ethereum smart contract.

(203) Determine the functions implemented by database technology. Based on the mature and stable characteristics of the database, and the string type data in the blockchain smart contract is very incompatible, which seriously affects the performance, the function that does not violate the principle of a distributed transaction is deployed in the database, that is, the storage of user registration information. After logging in, users can view and modify personal information. At the same time, all transaction parties in the blockchain transaction information are initially displayed with the blockchain account address. Through the peer-to-peer mapping relationship between the account address and the name stored in the database, the two parties in the transaction are changed to the name display.

A method for building a multi-energy trading and management platform based on blockchain according to claim 1, characterized in that, step (2) includes the following steps:

(301) Build a multi-energy trading system based on the combination of blockchain technology and database, and divide it into four parts: blockchain layer, smart contract layer, front-end interaction layer, and database layer;

(302) Create a project instance based on the cloud server platform. After creating the project file, configure the dependencies required by the Ethereum Geth client, configure the genesis block file for initialization, and then start the private chain and allow other nodes to join to complete the private chain;

(303) Compile the smart contract used for energy transactions with Remix online compiler. Remix automatically generates a contract application binary interface (ABI) and byte-code, and save them in the same directory as the server project file in the j son file format, Then connect the private chain, configure the private chain in a nodejs environment, and complete the contract deployment;

(304) Use ether.js in JavaScript to build the interface between the smart contract and the client to call the functions in the contract. The contract sends a remote procedure call (RPC) to Geth, Geth reads the transmitted function and call address, and executes corresponding instructions, and completes the internal call of the smart contract by the client. At the same time, according to the connection between the client and the smart contract, the energy information and transaction information data stored in the smart contract are returned to the client, and a user-friendly interface is generated with the help of the Vue+element framework.

(305) When a user registers, the registered information and the generated blockchain account address are submitted to server. According to the peer-to-peer mapping relationship between blockchain address and the real name, when the user views the transaction in blockchain, both parties to the transaction are displayed by their names.

The beneficial effects of the invention are reflected as follows:

(1) The invention provides a method for building a multi-energy trading and management platform based on the combination of blockchain technology and a database. This method can skillfully avoid the problems of low performance and low visibility of data type in blockchain technology. It saves user information according to the database function and establishes the mapping relationship with the blockchain, which is not in conflict with the distributed trading principle but also enhances the system availability. So it meets the basic requirements of the current application. Nowadays, with the increasing demand for the development of blockchain technology and the reasonable combination of traditional database technology, the invention can be easily used in distributed energy trading and management applications.

(2) The invention can make the main function of energy distributed transaction still be realized according to the blockchain technology, and realize the functions of free release between users and automatic matching of the system. At the same time, users can query all transaction information according to the blockchain, which ensures the openness and distributed demand of transactions.

(3) The invention can effectively solve the problem that most of the current blockchain in the field of energy trading is still limited to simulation analysis and testing, and the common user has a high participation threshold. At the same time, the invention puts forward effective measures to solve the difficulties in the transformation from experiment to application of blockchain technology in the field of energy trading, which can be further studied by engineering developers.

### BRIEF DESCRIPTION OF THE FIGURES

FIG. 1 shows the overall structure of the energy trading system

### DESCRIPTION OF THE INVENTION

The invention is described in further detail below in connection with the drawings and embodiments.

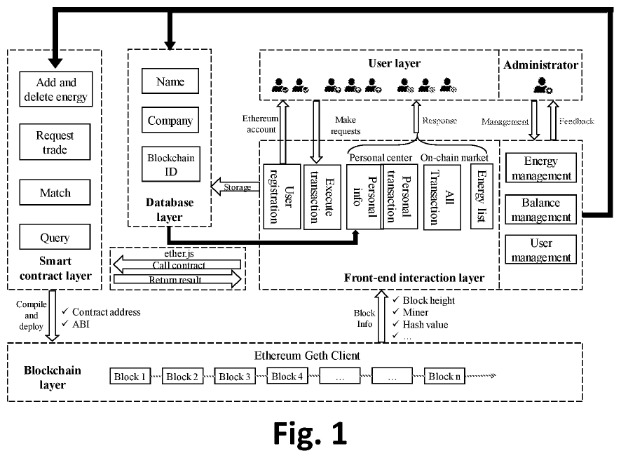

According to the proposed multi-energy trading and management building method, the energy trading system can be divided into four parts: blockchain layer, smart contracts layer, front-end interaction layer, and database layer. The structural connection between the four parts is shown in FIG. 1. The following is a detailed description of how the database can be used in the blockchain-based system without violating the principle of decentralization, followed by a description of the logical process and coordination mechanism of the four parts of the system, starting from the functions realized by the invention.

1. Matching Process Between Database and Blockchain Technology

1) Underlying technology: Building a database based on MySQL, while implementing the backend based on nodejs+egg.js, using the ethereum Geth client as the underlying layer, and using Solidity to write smart contracts.

2) Connection rights: When the database and backend are deployed to the server, the database is closed to external connections and can only be accessed internally by the server; the backend is allowed to access the database.

3) Separation of functions: The transaction module and the user module of the system are separated. The database mainly realizes the storage of user registration information, and users can view and modify their personal data after logging in, while all transaction information is displayed with real names.

4) User registration is defined as the following sequence of operations.

i) Use dedicated ether.js in Ethereum smart contract to randomly generate a key pair and convert it into a private key and address, that is to generate the user's account information.

ii) Use ether.js to generate the signature of the private key and address.

iii) Send the name, ID number and other information written by users, as well as the generated address and signature (excluding the private key) to the back-end program of the server.

iv) The back-end program uses the signature to verify the address. If the address calculated from the signature is the same as the address sent by the client, the following steps are allowed, otherwise, this behavior will be prevented.

v) Store the address, name, ID number and other information in the database (not including the private key) to form mapping information.

5) Design the view interface with the following logic.

i) The server accepts a number of parameters, including addresses and signatures, as well as a mapped list of user addresses to be queried.

ii) the back-end program uses the signature to verify the address, if the address calculated from the signature is the same as the address sent by the client, then the later steps are allowed, otherwise, this behavior will be blocked.

iii) Based on the address mapping list of users to be queried, read out the addresses, names, and other information corresponding to these users from the database, and return the information.

6) Name and address mapping replacement of transaction information, with the following sequence of operations.

i) Use ethers.js to generate a signature associated with the currently logged-in private key and address.

ii) Call the server to search the address same as the logged-in current user.

iii) If the verification is passed, the corresponding name will be searched from the mapping list, and the true name is displayed in the trading pipeline verifiably.

2. Analysis of System Architecture from the Perspective of Multi-Energy Trading and Management System Function

1) Administrator Function

Administrators have no interference in the energy trading process, which ensures the distributed characteristics of the energy blockchain. However, market access mechanisms are still required in energy transactions. Traditional solutions, which rely entirely on centralized databases and allow administrators to enter the market after reviewing user submissions, still have trust issues. This is due to the fact that invoking smart contracts in the blockchain (which, for users, means triggering events such as applying for a transaction) requires a certain amount of gas fees. This system will recharge a certain amount of gas fee for each initial user. After the handling fee is exhausted, if the user wants to continue to use it, he/she needs to apply to the administrator for market access. The administrator will audit according to the basic personal information in the database. After passing the audit, the corresponding gas fees will be transferred to the user's blockchain address to complete the market access in this way. At the same time, such a transfer will also be recorded on the blockchain, ensuring the openness of the information.

The second function of the administrator is to manage the energy types. Since different types of energy determine which energy users can trade, this part of the function relies on the implementation of the smart contract in the blockchain, which makes the energy trading system have good scalability, realize the complementarity of multiple energy sources and the participation of multiple users.

2) User Registration

The registration interface is designed in the front-end interaction layer. Ordinary users register according to the interface guidelines, then the basic personal information is saved in the database layer. At the same time, an application is issued to the blockchain layer. After successful registration, the individual blockchain address and private key will be obtained. The address and private key will be used in subsequent transactions, which are also the characteristics of the blockchain itself, ensuring the security and privacy of transactions.

3) Buyers and Sellers Release Transaction Information

In this interface, users can apply for an energy transaction. The information submitted includes energy type, trading identity, transaction quantity and expected price.

After confirmation, the front-end interaction layer will interact with the smart contract through the Ether.js interface, storing data in the smart contract's matchmaking information structure, and executing the matching function of the smart contract at the same time.

4) Personal Center

The Personal center includes personal data, personal releases, and personal transactions. The contents of the personal data are returned primarily by the database in which the information is stored. Personal publishing shows the transactions released by users to the market, while personal transaction shows the transactions successfully matched. On the one hand, the transaction flow is the proof of previous transactions; on the other hand, the transaction flow plays a certain reference role for the reasonable quotation after.

5) Market on Blockchain

The on-chain market includes energy lists, all releases, and all transactions. The energy list summarizes all the energy untraded data in the current market, making it easy for users to quickly analyze the market supply and demand relations. Taking the listed energy of the current system as an example, we can see that the supply of electricity and water is in excess of demand, and the supply of gas is in short supply. However, there is still a piece of purchase information for electricity, which can be inferred that the quotation is too low and the system has not matched it.

TABLE 3
Residual energy information in current systems

| Energy | | Number of | Total | Number of | Total purchase |
|---|---|---|---|---|---|
| types | units | sales | sales | purchases | amount |
| electricity | KWh | 3 | 500 | 1 | 200 |
| water | m³ | 2 | 30 | 0 | 0 |
| gas | m³ | 0 | 0 | 3 | 100 |

In addition, the user can see all the successful transaction information, including the transaction time, transaction parties, transaction energy, transaction volume and transaction price, etc. Firstly, the transaction information is returned by the smart contract layer. Then, according to the mapping relationship between the names stored in the database and the blockchain address, the transaction parties in the transaction information are replaced by real names. More importantly, different from the traditional transaction information, each transaction is recorded on the blockchain, which also contains the elements of the blockchain itself, such as block height, block hash, parent block hash, etc., which are transferred in by the blockchain layer. This information does not have much reference value for users, but each user can get the complete information of the blockchain, that is, their copy, which is very important to ensure the fairness, openness, and unforgeability of the whole trading system.

1. A method for building a multi-energy trading and management platform based on blockchain, characterized in that, includes the following steps:
(1) based on the characteristics of blockchain decentralization and the advantages of stable performance of traditional databases, the combination of blockchain technology and database technology is used in different functions of this invention. Blockchain technology is used for multi-energy distributed transactions and traditional databases are used to store complex string data. The system performance is improved and the resource consumption is reduced without violating the characteristics of distributed transactions;
(2) build a complete multi-energy transaction and management system based on the combination of blockchain technology and database. The system structure includes four parts: blockchain layer, smart contract layer, front-end interaction layer, and database layer.

2. A method for building a multi-energy trading and management platform based on blockchain according to claim 1, characterized in that, step (1) includes the following steps:
(201) determine the functions implemented by the energy trading platform. For users, the energy trading platform can enable users to issue transactions, view personal transaction results, view blockchain information generated by the exchange, view and change personal registration information, etc. For administrators, it is able for them to transfer money to a user, check the user's personal information and manage energy, etc.;
(202) determine the functions implemented by blockchain technology. Based on the distributed characteristics of blockchain technology, the main part of the energy transaction is deployed on blockchain, which includes releasing energy, matching transactions automatically, and viewing the transaction results and the blockchain information generated by it. Meanwhile, users tend to trade in different types of energy, so the function of adding or deleting energy is also placed in blockchain. All the above functions are realized based on Ethereum smart contract;
(203) determine the functions implemented by database technology. Based on the mature and stable characteristics of the database, and the string type data in the blockchain smart contract is very incompatible, which seriously affects the performance, the function that does not violate the principle of a distributed transaction is deployed in the database, that is, the storage of user registration information. After logging in, users can view and modify personal information. At the same time, all transaction parties in the blockchain transaction information are initially displayed with the blockchain account address. Through the peer-to-peer mapping relationship between the account address and the name stored in the database, the two parties in the transaction are changed to the name display.

3. A method for building a multi-energy trading and management platform based on blockchain according to claim 1, characterized in that, step (2) includes the following steps:
(301) build a multi-energy trading system based on the combination of blockchain technology and database, and divide it into four parts: blockchain layer, smart contract layer, front-end interaction layer, and database layer;
(302) create a project instance based on the cloud server platform. After creating the project file, configure the dependencies required by the Ethereum Geth client, configure the genesis block file for initialization, and then start the private chain and allow other nodes to join to complete the private chain;
(303) compile the smart contract used for energy transactions with Remix online compiler. Remix automatically generates a contract application binary interface (ABI) and byte-code, and save them in the same directory as the server project file in the j son file format, Then connect the private chain, configure the private chain in a nodejs environment, and complete the contract deployment;
(304) use ether.js in JavaScript to build the interface between the smart contract and the client to call the functions in the contract. The contract sends a remote procedure call (RPC) to Geth, Geth reads the transmitted function and call address, and executes corresponding instructions, and completes the internal call of the smart contract by the client. At the same time, according to the connection between the client and the smart contract, the energy information and transaction information data stored in the smart contract are returned to the client, and a user-friendly interface is generated with the help of the Vue+element framework;
(305) when a user registers, the registered information and the generated blockchain account address are submitted to server. According to the peer-to-peer mapping relationship between blockchain address and the real name, when the user views the transaction in blockchain, both parties to the transaction are displayed by their names.
